(19) United States
(12) Patent Application Publication
(10) Pub. No.: US 2015/0242531 A1
(43) Pub. Date: Aug. 27, 2015

(54) DATABASE ACCESS CONTROL FOR MULTI-TIER PROCESSING

(71) Applicant: International Business Machines Corporation, Armonk, NY (US)

(72) Inventor: Leonid Rodniansky, Allston, MA (US)

(73) Assignee: International Business Machines Corporation, Armonk, NY (US)

(21) Appl. No.: 14/189,239

(22) Filed: Feb. 25, 2014

(51) Int. Cl. G06F 17/30

(52) U.S. Cl. CPC G06F 17/30917; G06F 17/30091; G06F 17/30864

(57) ABSTRACT

Embodiments of the disclosure can include a method, a system, and a computer program product for controlling access to a database server in a multi-tiered processing system. The method can include receiving an application request having an identification parameter to an application server at an application layer. The method can also include querying a database objects map that maps the application request to a database object and a database operation in a database layer. The method can also include accessing one or more database access security rules for the identification parameter that specify a security action based on the database object and the database operation. The method can also include comparing the database object and database operation determined from the application request with the database object and database operation from the one or more security rules.

### BACKGROUND

The present disclosure relates to database access control, and more specifically, to database access control on multi-tiered processing systems.

Modern information processing environments can use an application-server model instead of the traditional client-server model. The application-based architecture allows each application to perform specific and/or specialized portions of processing before handing a transaction or data stream off to a successive processing tier. An application-server model may utilize a multi tier arrangement or architecture. In a multi-tier arrangement, each tier is responsible for performing a particular aspect of processing, e.g., database or application tiers can process different data. Different tiers communicate by passing or transmitting data, often according to a predetermined protocol or data structure. A business transaction is therefore passed between tiers, which may be successive layers or nodes in the processing stream. Accordingly, each tier “layer” receives a transaction from a preceding layer.

Each tier may perform particular functions, such as database queries, XML parsing, tunneling, protocol mapping, network transport, or GUI (graphical user interface) operations, for example. At each tier, attributes of the transaction or data stream are communicated to the next tier. However, certain attributes may be suppressed or omitted if those attributes are deemed unnecessary at the successive tier. Therefore, in a multi-tier arrangement, while scaling, information scope, and function consolidation may be improved, certain attributes of the transaction or information stream may not be propagated as readily as in conventional client server arrangements. Operations or functions that expect certain attributes available at a particular layer may encounter difficulty (i.e. unavailability) relying on that attribute.

### SUMMARY

Embodiments of the disclosure can include a method, a system, and a computer program product for controlling access to a database server in a multi-tiered processing system.

One embodiment can be directed toward a method for managing access to a database server. The method can include receiving an application request having an identification parameter to an application server at an application layer. The method can also include querying, at the application layer, a database objects map that maps the application request to a database object and a database operation in a database layer. The method can also include determining the database object and the database operation for the application request from the database objects map. The method can also include accessing one or more database access security rules for the identification parameter that specify a security action based on the database object and the database operation. The method can also include comparing the database object and database operation determined from the application request with the database object and database operation from the one or more security rules. The method can also include performing the security action in response to the database object and database operation determined from the application request being substantially similar to the database object and database operation from the one or more security rules.

Another embodiment can be directed toward a system for managing access to a database server. The system can include an application server that is configured to receive an application request having an identification parameter using a front-end application. The system can include a database access security rule repository containing one or more security rules for the identification parameter that specify a security action based on the application user and a database object and a database operation. The system can include a database objects map containing one or more application requests mapped to a database object and a database operation. The system can include a front-end access control system configured to receive, at an application layer, the application request having the identification parameter. The front-end access control system can be configured to query the database objects map. The front-end access control system can be configured to determine the database object and the database operation for the application request from the query. The front-end access control system can be configured to access one or more database access security rules. The front-end access control system can be configured to compare the database object and database operation determined from the application request with the database object and database operation from the one or more security rules. The front-end access control system can be configured to perform the security action in response to the database object and database operation determined from the application request being substantially similar to the database object and database operation from the one or more security rules.

Another embodiment can be directed toward a computer program product.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a flowchart of a method for implementing a security rule for an application request from a user on an application layer, according to various embodiments.

FIG. 2 illustrates a flowchart of a method for mapping the application request to a database object and database operation, according to various embodiments.

FIG. 3 illustrates a block diagram of a system that uses the database access control, according to various embodiments.

FIG. 4 illustrates a block diagram of a system that implements a database security access rule, according to various embodiments.

FIG. 5 illustrates a block diagram of automated computing machinery, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to database access control, more particular aspects relate to database access control on multi-tiered systems. In various multi-tiered systems involving an application layer (tier) and a database layer (tier), access to the database can be controlled by a security mechanism existing within the database layer. However, when the access to the database is prevented, the security mechanism can eliminate a session between a database layer and an application layer which causes performance degradation.

Aspects of the present disclosure can relate to controlling access to a database at a security manager based in the application layer which can preserve the session between the database layer and the application layer. The security manger in the application layer can receive an application request for an identification parameter that involves a database object and a database operation in the database layer. The security manager can read a database objects maps that maps the application request to a database operation and database object.

The security manager can compare the database operation and the database object for the application request to one or more security rules for the identification parameter. The security rules can specify a security action to take when the security rule database object and security rule database operation are present. Database access can be controlled by checking the database operation and database object for the application request against the security rule database operation and the security rule database object for an identification parameter. If there is a match, then the security manager can initiate the security action within the application layer while preserving the session. While the present disclosure is not necessarily limited to such applications, various aspects of the disclosure may be appreciated through a discussion of various examples using this context.

Information, e.g., security functions, can be lost between operations performed at different tiers/layers of an application-server based system. Security functions can be based on a credential. In some cases, the security function is provided by the same layer that provides an identity layer. For example, when a user connects directly to a database there may be an identification parameter, e.g., a user name, that is used to log onto the database. The same user name can also be used to define privileges in the database system and the same name can appear in the audit trail generated by audit security mechanisms. This may be true regardless of whether the database itself is the system enforcing access control rules and performing the auditing or an external security system performs these functions. Because the user name used for the security functions may be managed by the database security tier, it may be meaningful to the security operator, who defines privileges or reviews the audit trail.

There may be cases in which the security function is provided at one tier while the identity is provided by another tier. A very common case involves application servers that use a database as their back-end. In such cases, the application may be the tier responsible for managing the identities. A user logs onto the application and provides, for example, a user name and a password. The application will typically utilize a database on the back-end to store and manage the data used or accessed via the application. The application server uses connections to the database.

In the application-server based architecture, the application server maintains a pool of connections to the database, e.g., a database connection pool. These connections may be created when the application server first starts and they can use a single functional account, i.e. the connections are all associated with a single functional identifier for the application front-end without distinguishing between users of the application front-end. These connections may be reused by various user sessions, i.e. multiplexing is used. That is, when a user logs onto the application front-end, a session is created with the application front-end and the application front-end gets a connection from the database's connection pool and assigns it to the session. When the session ends, the connection is released back to the pool and may be reused by the application front-end for another session.

This connection pool mechanism used by the application server can cause a serious security problem. The identity of the user is lost from the viewpoint of the database layer, i.e. the user identity is not passed to the database back-end, and only exists at the application layer, i.e. at the application front-end. For example, if one were to look at an audit trail produced by an audit mechanism operating at the database layer, such as an audit mechanism of the database itself or a Database Activity Monitoring system, then the activity can be performed by the entity logged onto the database, i.e. the functional account of the application which is identified by a functional identifier. However, what Database access control security mechanism (DACSM) wants to be able to know is which end-user of the application layer caused the particular database query to be issued and therefore, which user was able to access certain sensitive data. The access control system has little useful information from a security point of view because the “real identity” of the end-user is not propagated through the application layer.

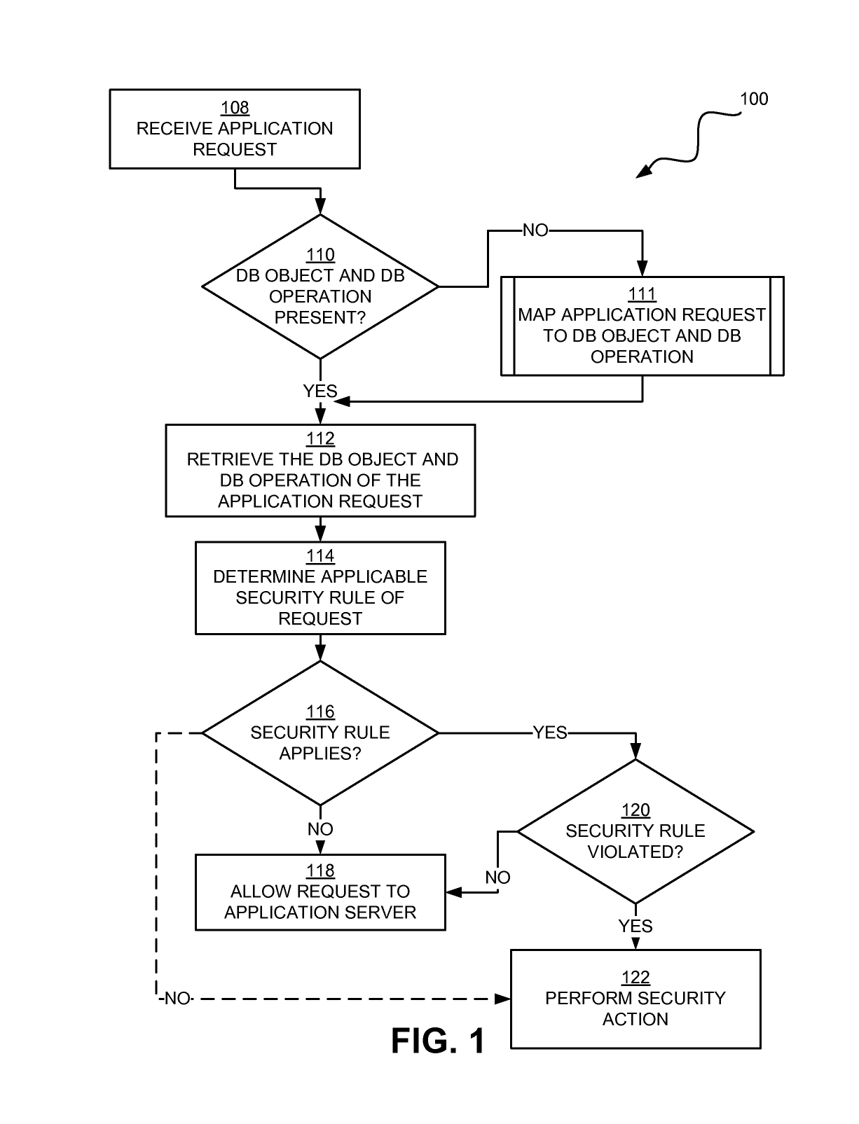

FIG. 1 illustrates a flowchart of a method 100 for implementing a security rule for an application request from a user on an application layer, according to various embodiments. The application request can refer to the front-end application requesting data from a database accessible to an application server. The term application request can be used interchangeably with the term front-end request. The application request can occur in the application layer of a multi-tier system. The method 100 can be implemented by a front-end access control system (FACSM). The method 100 can involve the FACSM initiating a security action, e.g., dropping the application request, for users or other front-end application identification parameters without the necessary database permissions. The method 100 can begin at operation 108.

In operation 108, The FACSM can receive an application request from a front-end application. The application request can have an identification parameter. The identification parameter can specify any front-end application condition. For example, the identification parameter can refer to a user, or an internet protocol (IP) address of a computing device, e.g., a mobile phone, that accesses the front-end application. The identification parameter can also refer to a time-based identification parameter. For example, the identification parameter can include a date or a time of when the application request is sent.

In various embodiments, the FACSM can intercept the application request from the front-end application to an application server. The application request can be held by the FACSM or can be allowed to pass thru the FACSM. The application request to the application server can include a Uniform Resource Locator (URL) that directs the front-end application to the application server and, in particular, a database resource, e.g., a database object and database operation.

The database object can be a data structure used to either store or reference data. For example, the database object can be a table, an attribute of a table, an index, stored procedures, sequences, or views. Database operations can be a set of tasks defined by the application and can include simple or composite operations. Database operations can include operations typically found in a structured query language (SQL). An example of a database operation is a SELECT operation, but other database operations are contemplated such as DELETE, CREATE, SHOW, USE, WRITE, MODIFY, etc. After the application request is received, then the method 100 can continue to operation 110.

In operation 110, the FACSM can determine whether the database object and the database operation that corresponds to the application request is present in the database objects map. The FACSM can search a database objects map. The database objects map can be a file such as an XML file that maps the application request at the application layer to the database object and database operation in the database layer. The database objects map can be implemented in a variety of ways. For example, if the application request for user A is for a particular address, then the application server can determine that the application request at the particular address involves a WRITE to table B. The database operation WRITE and the database object, table B, can be written to the database objects map with reference to the application request.

The database objects and database operation for previous application requests can also be saved into the database objects map to facilitate fast access to the database object and the database operation information associated with the application request. If the database object and the database operation for the application request are not present in the database objects map, then the method 100 can continue to operation 111. If the database object and the database operation are present, then the method 100 can continue to operation 112.

In operation 111, the FACSM can initiate a mapping of the application request to a database object and database operation. In various embodiments, the FACSM can initiate the mapping by forwarding the application request to the application server with limited processing instructions. For example, the FACSM can allow the application request but include a limitation that an inspection system can only determine the database object and the database operation for the application request. The inspection system can inspect a database request in the database layer and can include components such as a runtime learning manager (RLM) that reads each database request. The inspection system can provide instructions to update a database objects map. In this example, the application server can bypass the database server to produce a faster update to the database objects map.

Operation 111 can occur independent of method 100, according to various embodiments. For example, the creation of the database objects map can be performed in the background during low peak activity. The creation of the database objects map can be continuously updated based on the prior application request. For example, if the database objects map saves a first application request with the corresponding database object and the database operation, and the FACSM receives a second application request that is identical to the first application request at a later time, then the FACSM can use the database object and the database operation for the first application request. Once the database objects map is populated with the database object and the database operation for the application request, then the method 100 can continue to operation 112.

In operation 112, the FACSM can retrieve, from the database objects map, the database object and database operation that corresponds to the application request. For example, the FACSM can search the database objects map for the application request, e.g., a uniform resource locator (URL) of an application request, and receive the database object and the database operation that corresponds to the application request. After the database object and operation are retrieved by the FACSM, then the method 100 can continue to operation 114.

In operation 114, the FACSM can determine the applicable security rule of the application request based on the identification parameter. The security rule can contain a security rule database object and a security rule database operation. The security rule database object and the security rule database operation can be the same or different than the database object and database operation determined in operation 112. In various embodiments, the FACSM can interact with a database access security rules (DASR). The DASR can hold various security rules for a given identification parameter.

The security rule in the DASR can also specify security actions. For example, the DASR can specify that user A is allowed READ access to a table B but not other data tables and not WRITE access. The DASR can specify that if user A does not have the READ access, then the FACSM can drop the application request. In various embodiments, drop can refer to rejecting the application request, not forwarding the application request, or can refer to blocking the application request to the application server. Either the application request can be blocked, or the response from the application server can be blocked. Other security actions can involve actions taken by the FACSM in response to the security rule not being satisfied. The security actions can also include rerouting the application request to another application server with more lenient permissions, and also modifying the application request.

The security rule for the identification parameter, e.g., a user, can be determined by an administrator and uploaded to the DASR independent of other operations. The applicable security rule can be determined based on the identification parameter, e.g., the user or other front-end application parameter. For example, the FACSM can search the DASR for the applicable security rule/access level for user A. In this example, the FACSM can determine that user A has a database operation of READ for the database object table B.

In another example, an application request can have an identification parameter of a particular IP address. The FACSM can search the DASR for the identification parameter and find the particular internet protocol (IP) address. Once found, the FACSM can search the applicable security rule for the particular IP address. If the security rule specifies to block an application request that requests from table A for the particular IP address, then the application request can be blocked.

In another example, the security rule may be based on a time-based identification parameter. If the security rule specifies to block an application request that requests from table FUTURE_WORK, when current DATE is before Feb. 15, 2014, then the identification parameter, e.g., the date of the application request, can be used to determine if the rule applies. If the date of the application request is Jan. 29, 2014, then the security rule may apply.

According to various embodiments, more than one security rule can apply for a given condition. For example, the identification parameter can specify a certain user from a certain internet protocol (IP) address. The FACSM can read the identification parameter and the security rule for the certain IP address may allow a READ to a data object, but the security rule may allow the certain user to WRITE to a data object. In the event of a conflict between two security rules, a system policy may indicate a preference. In the above example, if the preference was toward a user over a location, then the user may WRITE to the data object. Once the applicable security rule is determined, then the method 100 can continue to operation 116.

In operation 116, the FACSM can determine if there is a security rule that applies for the given identification parameter. An identification parameter for an application request may not exist in the DASR, which would make no security rule apply. For example, a user, IP address, or other front-end distinguishing characteristic may not be included in the DASR and therefore no security rule may apply.

The FACSM can determine what happens to an identification parameter for the application request that does not exist in the DASR based on a policy. The policy can indicate that if there are no security rules for the identification parameter, then the application request is blocked and the method 100 can continue to operation 122. Thus, the DASR would contain only the information of allowed users.

In various embodiments, the FACSM can include the policy where if there is no security rule for the identification parameter, then the FACSM can allow the request to the application server in operation 118. Thus, the DASR could contain only restrictions on flagged users. If there is a security rule that applies for the identification parameter, then the method 100 can continue to operation 120.

In operation 120, the FACSM can determine if security rule is violated for the application request. The FACSM can access the database objects map and determine that the database object for the application request is TABLE B and the database operation is WRITE. For example, the FACSM can access the security rule for user A which can indicate that user A is allowed access to a database object of TABLE B with a database operation of a READ. Since user A does not have an access level of WRITE, then the FACSM can determine that user A does not meet the security rule. The security rule can indicate a security action such as dropping the application request.

In various embodiments, if the database object and the database operation for the security rule are substantially similar to the database object and the database operation for the application request, then the security rule can be determined not to be violated. The term “substantially similar” can mean identical. For example, if the application request and the security rule both specify identical database operations, but the security rule specifies a database object of table A for employees hired after 1995 and the application request specifies a database object of table B for employees hired before 1995, the FACSM can determine that table A is substantially similar to table B and determine that the security rule is not violated. Substantially similar can also refer to a class or a range of database operations or database objects that the user can access. If the FACSM determines that the user has violated a security rule, then the method 100 can continue to operation 122. If the FACSM determines that the security rule is not violated, then the method 100 can continue to operation 118.

In operation 118, the FACSM can allow the application request from the front-end application to the application server. The application server can perform the database operation for the user. In operation 122, the FACSM can perform a security action. The security action can include dropping the application request to the application server. In various embodiments, the FACSM can drop the application request by terminating the connection to the application server. The FACSM can drop the application request by not allowing the request to the uniform resource locator (URL) be fulfilled by the application server. In various embodiments, the FACSM ignoring the URL can also drop the application request. For example, the FACSM can treat the URL like an invalid link and call an error. The security action can also include rerouting a request or modifying the original application request to an appropriate level.

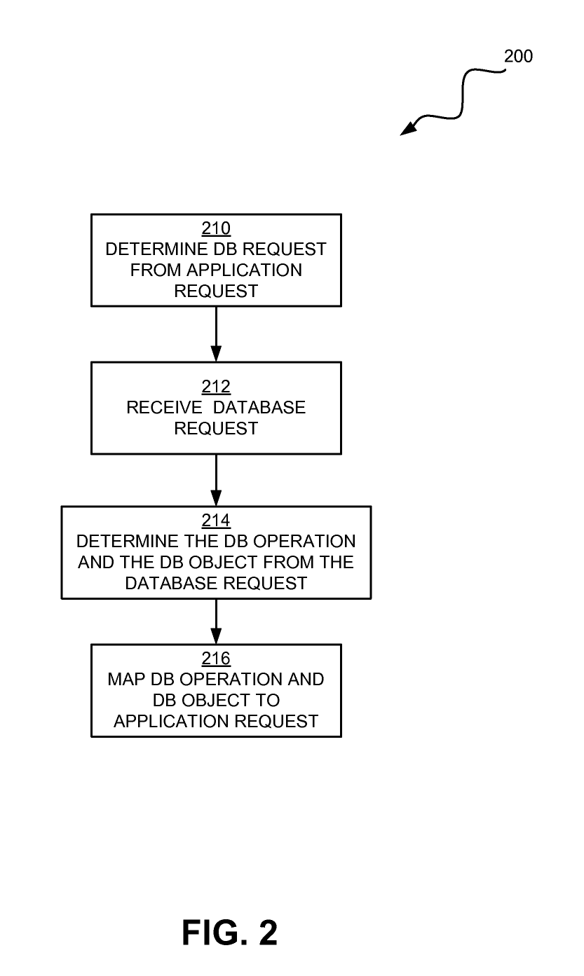

FIG. 2 illustrates a flowchart of a method 200 for mapping the application request to a database object and database operation, according to various embodiments. The method 200 can correspond to operation 112 from FIG. 1. The method 200 can include the creation or updating of the database objects map. For example, if no database objects map exists, then the database objects map can be created and then populated with the database object and the database operation. The method 200 can begin at operation 210.

In operation 210, the runtime learning module of the inspection system can determine the database request from the application request. In various embodiments, the FACSM can forward the application request to the application server with limitations. The limitations can include not fetching the database objects of the database request. In various embodiments, the runtime learning module of the inspection system can determine the database object and the database operation from the application request. For example, if an application request points to a URL of the application server, the URL may correspond to the database object and the database operation that the application server needs to access on the database layer. The application server can further communicate to a database entity, e.g., a database connection pool or a database server. The application server can communicate a database request for the database object and the database operation from the application request. For example, the database request can be a series of Structured Query Language (SQL) commands. In various embodiments, the FACSM can direct the application request to the inspection system and the inspection system can intercept the database request of application server. When the database objects map is being updated an application server can direct the database request to a database server. Once the database request is determined, the method 200 can continue to operation 212.

In operation 212, the database access control security mechanism (DACSM) can receive the database request. The database request can be derived from the application request by the application server in operation 210. The DACSM can include a runtime learning module (RLM). The RLM can be configured to determine the database object and the database operation in the database request. The RLM can monitor the database object and the database operation as a result of prior database requests so that the database object and the database operation can be mapped to current database requests. Once the database request is received, then the method 200 can continue to operation 214.

In operation 214, the RLM can determine the database object and the database operation from the database request. The RLM can intercept the database request. The RLM can parse the database request in the inspection system. Statements can be extracted from database protocol packets, and the extracted statements are parsed and database object information can be extracted from the statements. In various embodiments, the RLM can also store a history of interactions with the database server to the database objects map. Once the database object and the database operation are determined, then the method can continue to operation 216.

In operation 216, the RLM can map the database object and the database operation to the application request. In various embodiments, the RLM can read the application request from the application server or any process downstream from the front-end application and associate the application request with the database object and the database operation in the database objects map. The RLM can update or write the database objects map with the application request associated with database object and the database operation.

The inspection system can associate the application request with any subsequent determination of the database object and the database operation. In various embodiments, operations 214, 216 can be performed simultaneously by the RLM. For example, the RLM can automatically match the database object and the database operation determined in operation 214 to the application request when updating the document objects map.

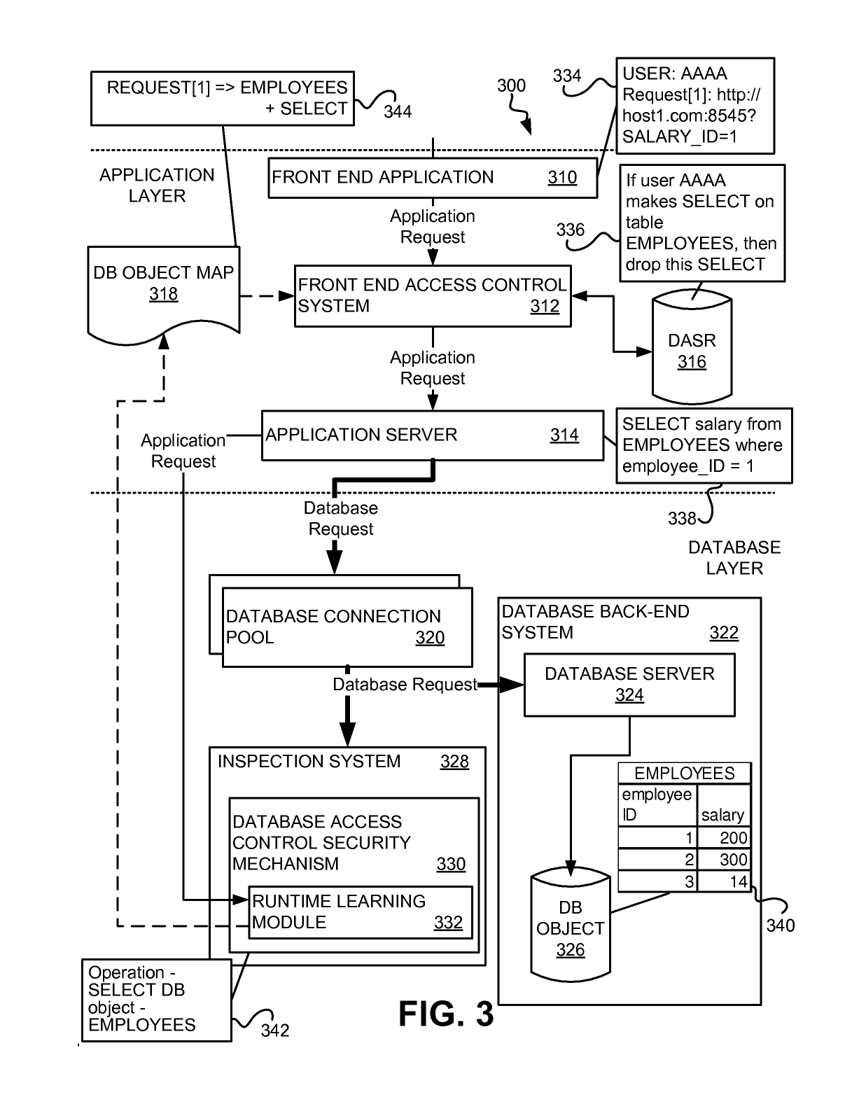

FIG. 3 illustrates a block diagram of a system 300 that uses the database access control, according to various embodiments. The system 300 can include components on both the application layer and the database layer. Components on the applications layer can include a front-end application 310, a front-end access control system (FACSM) 312, an application server 314, database access security rules (DASR) 316, and a database object map 318.

The application layer can interact with the database layer through the application server 314. The application server 314 can receive application requests from the front-end application 310. The application server 314 can process the application request. During the processing of the application request, the application server 314 can determine database processing actions from the database. For example, in an application that fetches data based on the user, then the application server 314 would need to produce database requests that fetch the desired data for the user to access on the application. Any number of database requests can result from the application request.

The database request can be in any format such as SQL commands. The database request can be received by the database connection pool 320. The database connection pool 320 can establish a connection to the application server 314 via a session as discussed herein. The database connection pool 320 can be always established for fast processing of database requests. The database connection pool 320 can exist in the database layer. The database connection pool 320 can further communicatively couple the session with a database back-end system 322 and an inspection system 328.

The database back-end system 322 can include a database server 324 which can access a database object 326. The database back-end system 322 can be responsible for accessing database objects and the corresponding records. The database server 324 can be a computer or a database accessing service. The database server 324 can access the database objects 326 from the database. The database object 326 can be provided to the application server 314 through the database connection pool 320.

The inspection system 328 can be isolated from the database back-end system 322 and not communicate with the database back-end system 322, according to various embodiments. The inspection system 328 can include a database control security mechanism 330 and a runtime learning module 332. The inspection system 328 can inspect the statements, e.g., SQL statements, generated by the application server 314. The inspection system 328 can store the database request, or at least an identifier of the database request, and its associated unique values as obtained from the database request.

The inspection system 328 can inspect the database requests that are destined for the database server 324. In various embodiments, the inspection system 328 can receive the database request simultaneously with the database server 324. The inspection system 328 can also be configured to receive the database request before passing the database request to the database server 324. The inspection system 328 can be a routine or a program within the database layer. The DACSM 330 can limit the database request to certain database operations. The DACSM 330 can contain a runtime learning module. The runtime learning module 332 can further update the database object map 318 using the database object 326.

In various embodiments, the runtime learning module 332 does not have access to database back-end system 322. The RLM 332 is part of inspection system 328 and may be non-intrusive. The Inspection system 328 can intercept database protocol data sent through the database connection pool 320 to the database server 324.

The RLM 332 can monitor the database object 326 for database operations. In various embodiments, the RLM 332 can examine the time interval of the database request and application request to determine the database object and the database operation mapped to application request. For example, if a database request is received within the past 5 milliseconds describing the database object 326, and an application request performed within the past 10 milliseconds, then the RLM 332 can map the database object 326 to the application request. The RLM 332 can write the information to the database object map 318.

To illustrate the operation of the system 300, an example of a user requesting salary information will be used. The user can interact with the front end application 310 and produce an application request 334 of salary information for a particular salary ID. The application request 334 can refer to a URL of the application server 314. The FACSM 312 can hold the URL in various embodiments until the user is cleared for the database operation.

The FACSM 312 can receive the application request 334 and search the DASR 316 for an applicable security rule. In this case, the security rule 336 can contain the database object and the database operation that is allowed for the user. Since the security rule specifies the database object and the database operation, then the FACSM 312 can consult the database object map 318. Assuming that the database object map 318 does not specify the database object and the database operation that corresponds to the application request, then the FACSM 312 can forward the application request to the application server 314 and inspection system 328 with instructions to map the application request to the database object and the database operation.

Once received, the application server 314 can create a database request 338. The database request can specify the database object and the database operation as well as the attributes to access on the database server 324. The database request 338 can be sent to the database connection pool 320 and to the inspection system 328. Assuming non-limiting instructions, the database server 324 may process the database request concurrent with the inspection system 328. The database server 324 can perform the database operation at the database object, e.g., 340. The database object can be an employee table 340 that lists the salaries for various employees. The database operation can be a select for the employee table 340, e.g., in database request 338. The runtime learning module 332 can determine the database operation and database object 342 of the database request and update the database objects map 318.

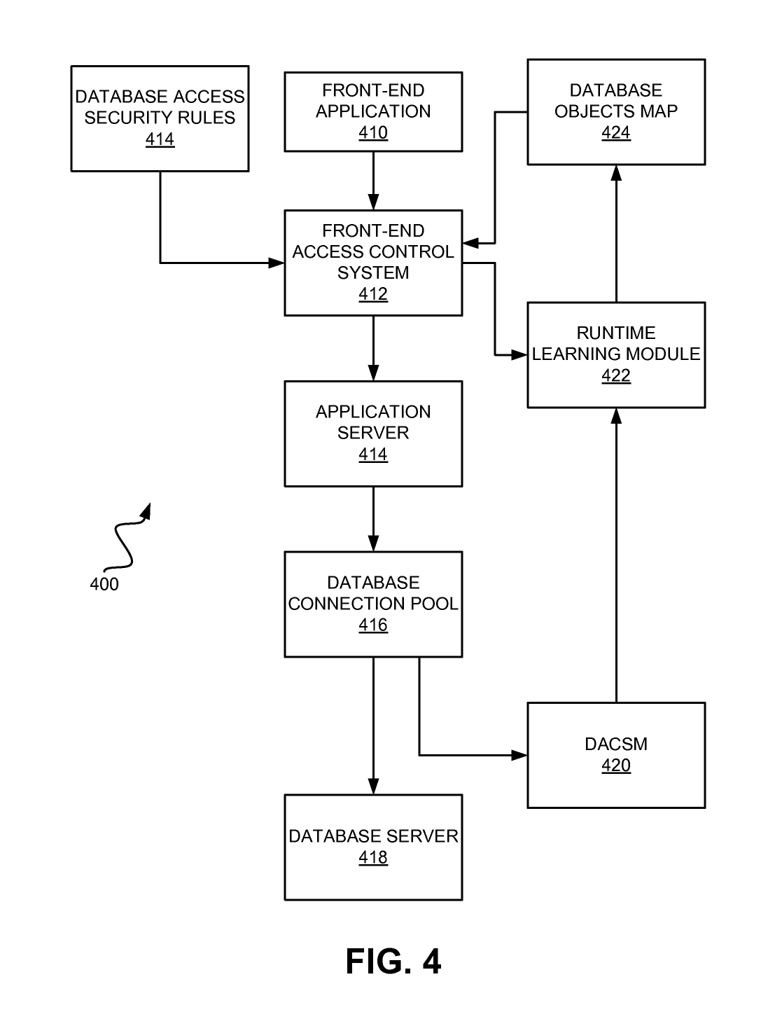

FIG. 4 illustrates a block diagram of a system 400 that implements a database security access rule, according to various embodiments. The system 400 can correspond to the system 300 in FIG. 3.

According to various embodiments, a front-end application 410 can send an application request to the application server 414. This application request can be intercepted by an inline FACSM 412. FACSM 412 can hold the intercepted application request, and retrieve database object and database operation information from the database objects map 424. The FACSM 412 can validate this information against the DASR 414. If a DASR 414 is violated, then FACSM 412 can block the intercepted application request to the application server 414. Otherwise the FACSM 412 can forward the application request further to the application server 414 and to the RLM 422.

The application server 414 can receive the application request and determine a database request from the application request. The database request can be sent to the database connection pool 416 which can further divert the database request to both the DACSM 420 and the database server 418. The database server 418 may process the database request.

The DACSM 420 can intercept the database request, and can parse these requests to the level of database objects and passes database objects information to the RLM 422. The RLM 422 can associate the application request with the database object and the database operation and update the database objects map 424.

The inspection system, e.g., DACSM 420 and runtime learning module 422, can read the database object and the database operation from the database request. Specifically, the RLM 422 can produce a RLM 422 database object and database operation. Once the RLM 422 database object and database operation is determined, the RLM 422 can associate the database object and the database operation with the application request and update the database objects map 424 with the RLM 422 database object and database operation and the application request. In various embodiments, the FACSM 412 can associate the database object and the database operation from the database objects map 424 with the application request. For example, the FACSM 412 knows the application request that was sent to the application server 414. The FACSM 412 can wait for a change in the database objects map 424 and associate the application request with the change in the database objects map 424. The database objects map 424 can map the application request with the database object and the database operation.

The FACSM 412 can then use the application request and the map 424 to determine that the user has a database operation of SELECT to a database object of employees. Following the security rule in the DASR 414, the FACSM 412 can drop the SELECT and not allow the request to the application server 414. In various embodiments, the FACSM 412 can alert the user of the lack of an access level.

Assuming that the identification parameter, e.g., user, has an appropriate security rule, the FACSM 412 can allow the front-end application to connect to a URL. Within the application layer, the processing of the application request is synchronous with other components in the application layer. The interaction between the database layer and application layer is asynchronous. For example, the database object and database operation of the database request can be updated into the database objects map 424 independent from the application request being processed in the application layer.

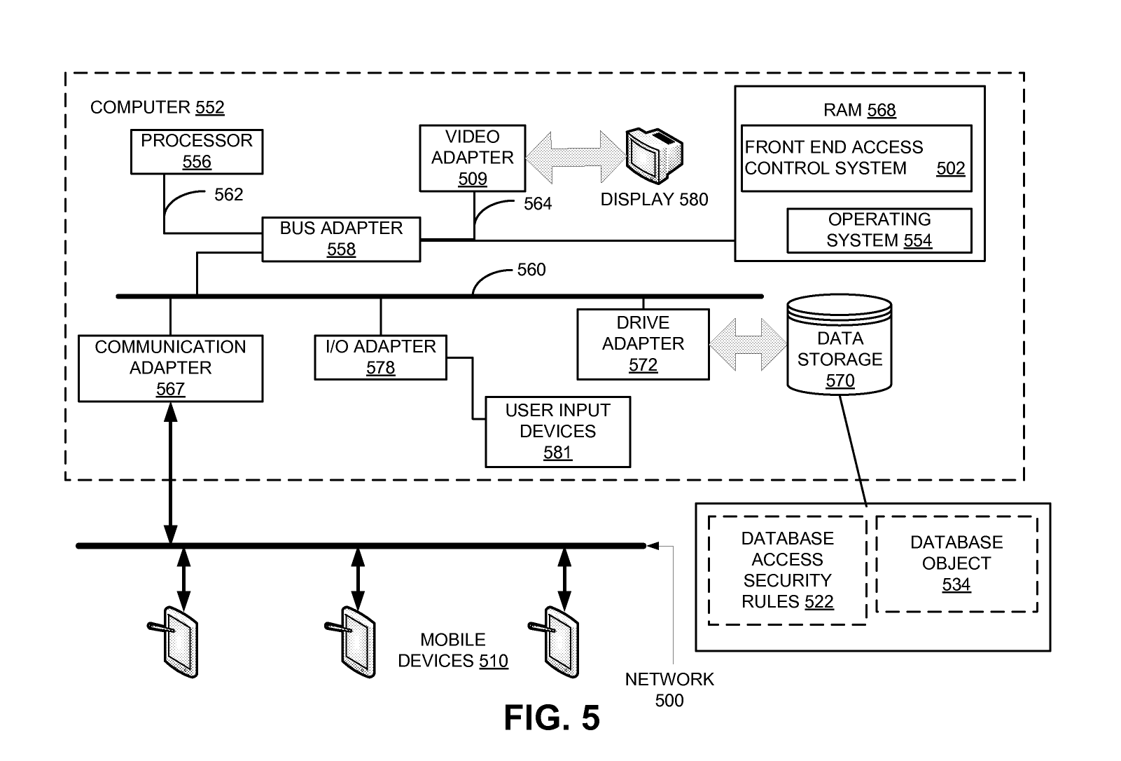

FIG. 5 illustrates a block diagram of automated computing machinery, according to various embodiments. The computing machinery can include example computer 552 useful in performing aspects of the disclosure, according to various embodiments. The computer 552 of FIG. 5 includes at least one computer processor 556 or ‘CPU’ as well as random access memory 568 (‘RAM’) which is connected through bus adapter 558 to processor 556 and to other components of the computer 552.

The RAM 568 can include the front end access control system 502. The front end access control system 502 can access database access security rules 522 and the database object map 534 to screen out application requests for a user based on the user's access level. The RAM 568 can include an operating system 554. Operating systems useful for record filtering according to embodiments of the present invention include UNIX®, Linux®, Microsoft XP™, AIX®, IBM's i5/OS™, and others. The operating system 554 are shown in RAM (568), but many components of such software typically are stored in non-volatile memory also, such as, for example, on a disk drive 570.

The computer 552 can also include disk drive adapter 572 coupled through expansion bus 560 and bus adapter 558 to processor 556 and other components of the computer 552. Disk drive adapter 572 connects non-volatile data storage to the computer 552 in the form of disk drive 570. Disk drive adapters useful in computers include Integrated Drive Electronics (IDE′) adapters, Small Computer System Interface (‘SCSI’) adapters, and others. Non-volatile computer memory also may be implemented for as an optical disk drive, electrically erasable programmable read-only memory (so-called ‘EEPROM’ or ‘Flash’ memory), RAM drives, and so on.

The data storage 570 can include one or more storage devices in a tiered configuration. The data storage 500 can be configured to have one or more database access security rules 522 and a database object map 534. The database object map 534 can relate an application request to a database object and database operation.

The example computer 552 includes one or more input/output (‘I/O’) adapters 578. I/O adapters implement user-oriented input/output through, for example, software drivers and computer hardware for controlling output to display devices such as computer display screens, as well as user input from user input devices 581 such as keyboards and mice. The example computer 552 includes a video adapter 509, which is an example of an I/O adapter specially designed for graphic output to a display device 580 such as a display screen or computer monitor. Video adapter 509 is connected to processor 556 through a high speed video bus 564, bus adapter 558, and the front side bus 562, which is also a high speed bus.

The example computer 552 includes a communications adapter 567 for data communications with other computers 510, e.g., mobile devices, and for data communications with a data communications network 500. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters include modems for wired dial-up communications, Ethernet (IEEE 802.3) adapters for wired data communications network communications, and IEEE 802.77 adapters for wireless data communications network communications.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Referring to FIG. 5, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving an application request having an identification parameter to an application server at an application layer;
querying, at the application layer, a database objects map that maps the application request to a database object and a database operation in a database layer;
determining the database object and the database operation for the application request from the database objects map;
accessing one or more database access security rules for the identification parameter that specify a security action based on a security rule database object and a security rule database operation;
comparing the database object and database operation determined from the application request with the database object and database operation from the one or more security rules; and
performing the security action in response to the database object and database operation determined from the application request being substantially similar to the security rule database object and security rule database operation from the one or more security rules.

2. The method of claim 1, further comprising:
establishing a session from the application server to a database server.

3. The method of claim 2, wherein the performing the security action includes:
dropping the application request to the application server.

4. The method of claim 3, wherein dropping the application request includes ignoring a Uniform Resource Locator (URL) to the application server.

5. The method of claim 2, wherein the performing the security action includes:
performing the security action while maintaining the session.

6. The method of claim 1, further comprising:
allowing the application request to the application server in response to the database object and database operation determined from the application request not being substantially similar to the security rule database object and the security rule database operation from the one or more security rules.

7. The method of claim 1, wherein querying a database objects map includes:
receiving a database request derived from the application request;
determining the database object and the database operation from the database request; and
mapping the database object and database operation to the application request in the database objects map.

8. The method of claim 1, wherein receiving the application request includes receiving the application request having the identification parameter that specifies a user.

9. A system comprising:
an application server that is configured to receive an application request from an identification parameter using a front-end application;
a database access security rule repository containing one or more security rules for the identification parameter that specifies a security action based on a security rule database object and a security rule database operation;
a database objects map containing one or more application requests mapped to a database object and a database operation; and
a front-end access control system configured to:
receive, at an application layer, the application request having the identification parameter,
query the database objects map,
determine the database object and the database operation for the application request from the query,
access one or more database access security rules for the identification parameter,
compare the database object and database operation determined from the application request with the security rule database object and the security rule database operation from the one or more security rules; and
perform the security action in response to the database object and database operation determined from the application request being substantially similar to the security rule database object and the security rule database operation from the one or more security rules.

10. The system of claim 9, further comprising:
a database server that is configured to establish a session with the application server.

11. The system of claim 10, wherein the front-end access control system is configured to perform the security action by:
dropping the application request to the application server.

12. The system of claim 11, wherein dropping the application request includes ignoring a Uniform Resource Locator (URL) to the application server.

13. The system of claim 11, wherein the front-end access control system is further configured to perform the security action while maintaining the session.

14. The system of claim 9, further comprising:
an inspection system configured to:
receive a database request derived from the application request;
determine the database object and the database operation from the database request; and
map the database object and database operation to the application request in the database objects map.

15. The system of claim 9, wherein the front-end access control system is configured to receive the application request by receiving the identification parameter that specifies a time-based identification parameter.

16. The system of claim 9, wherein the front-end access control system is configured to receive the application request by receiving the identification parameter that specifies an internet protocol (IP) address of a computer.

17. A computer program product for managing access to a database server, the computer program product comprising a computer readable storage medium having program code embodied therewith, the program code comprising computer readable program code configured to:
receive an application request having an identification parameter to an application server at an application layer;
query, at the application layer, a database objects map that maps the application request to a database object and a database operation in a database layer;
determine the database object and the database operation for the application request from the database objects map;
access one or more database access security rules for the identification parameter that specify a security action based on a security rule database object and a security rule database operation;
compare the database object and database operation determined from the application request with the security rule database object and the security rule database operation from the one or more security rules; and
perform the security action in response to the database object and database operation determined from the application request being substantially similar to the security rule database object and the security rule database operation from the one or more security rules.

18. The computer program product of claim 17, wherein the computer readable code is configured to establish a session from the application server to a database server.

19. The computer program product of claim 18, wherein the computer readable code is configured to perform the security action by:
dropping the application request to the application server.

20. The computer program product of claim 19, wherein the computer readable code is configured to perform the security action while maintaining the session.
